(19) United States
(12) Patent Application Publication
(10) Pub. No.: US 2002/0054404 A1
(43) Pub. Date: May 9, 2002

(54) Optical logic gates based on the polarization properties of four-wave mixing

(76) Inventors: Per Olof Hedekvist, Molndal (SE); Ashish Bhardwaj, Pasadena, CA (US); Kerry J. Vahala, San Gabriel, CA (US)

Correspondence Address: FISH & RICHARDSON, PC, 4350 LA JOLLA VILLAGE DRIVE, SUITE 500, SAN DIEGO, CA, 92122, US

(21) Appl. No.: 09/811,349

(22) Filed: Mar. 16, 2001

Related U.S. Application Data
(60) Provisional application No. 60/190,707, filed on Mar. 17, 2000.

(51) Int. Cl. G02F 3/00; G02F 1/09

(52) U.S. Cl. 359/108; 359/281

(57) ABSTRACT

Logic operations are carried out among multiple optical signals based on their wavelength. The logic operations can be based on four wave mixing which produces an output based on polarizations of the inputs. The same circuit can be caused to carry out multiple truth tables. Applications are disclosed for adding, logical inversion, and error correction. The error correction can take the form of parity bit generation or correction of data bits.

### CROSS-REFERENCE TO RELATED APPLICATIONS

The present application claims benefit of U.S. Provisional Application No. 60/190,707, filed Mar. 17, 2000 and No. 60/241,387, filed Oct. 16, 2000.

### STATEMENT AS TO FEDERALLY-SPONSORED RESEARCH

The U.S. Government may have certain rights in this invention pursuant to Grant Nos. F-49620-97-1-0014, F-49620-97-1-0512, and F-49620-98-1-0409 awarded by Air Force.

### BACKGROUND

Optical logic is known. Different kinds of optical gates have been suggested. These gates may use intensity modulation of the light, where the light level being off or close to off corresponds to a “0” and the light being on or greater than a specified intensity corresponds to a “1” or the opposite.

Other techniques such as frequency deviation modulation have also been suggested.

### SUMMARY

The present system defines a scheme using polarization properties of light to carry out logic operations. An embodiment drives nonlinearities in a media using the polarizations of input signals. The output represents the logical result between the signals.

More specifically, an embodiment defines an all optical logic system, using polarization properties of a nonlinear process. A light signal is formed which has some aspect of its spectrum that is modulated to represent a logic level. The state of polarization of the formed light signal is dependent on the combination of the states of polarizations of the input signals.

An embodiment four wave mixing among input signals of different wavelengths which are polarization modulated to form parallel bits. This logic operation can be an addition, or an error correcting Hamming code logic operation between the signals.

### BRIEF DESCRIPTION OF THE DRAWINGS

These and other aspects will now be described in detail with reference to the accompanying drawings, wherein:

FIGS. 1A-1D shows the features of four wave mixing on a plurality of signals;

FIG. 2 shows a basic diagram of using four wave mixing for logic operations;

FIG. 3 shows a basic block diagram of an error correcting circuit;

FIG. 4 shows a more detailed block diagram of the error correcting circuit;

FIGS. 5a-5c show forms of the error correcting circuit;

FIG. 6 shows the wavelengths of the different mixing products;

FIG. 7 shows a block diagram of a three bit adder in which multiple truth tables are carried out in each element;

FIG. 8 shows a wavelength diagram of different mixing products;

FIG. 9 shows formation of parity bits for an (7,4) Hamming code;

FIG. 10 shows a block diagram of formation of parity bits for such a Hamming code using the basic building blocks of the FIG. 7 adder;

FIGS. 11 and 12 show generators of the corrected codes for such a system;

FIG. 13 shows the multiple layers of gates that would be necessary to carry out a three bit add using two input logic; and

FIG. 14 shows the optical elements all on a single semiconductor substrate.

### DETAILED DESCRIPTION

An embodiment carries out a logical operation by modulating logic levels into polarization states of light, and combining the light using four wave mixing in a semiconductor optical amplifier.

Four wave mixing uses a fundamental process with third order nonlinearities to effectively multiply up to three bits of information. The four wave mixing technique is used in this embodiment to carry out a three bit Boolean operation based on polarization states of optical signals.

The bit assignments are carried out in a front end device, i.e. a device that is situated between a data bus, and an object of the data bus, where the object can be a computing device.

An embodiment disclosed herein may assign each bit of a binary word to a different wavelength, and copropagate the multiple wavelengths and hence multiple bits along a fiber. This may provide space savings, since a multiple line electrical bus may thus be compressed onto a single waveguide, e.g., a fiber. This may also simplify network architecture by eliminating the need for serializers and/or deserializers.

In this embodiment, the state of polarization (“SOP”) of the input signals represents the data being represented by the input signal. Different modulation formats can be used. A binary polarization shift-keying format may be used to encode the signal.

Using this format, a linear horizontal state of polarization could correspond to “0”, and a linear vertical state of polarization could correspond to “1” or the opposite. Using four wave mixing, three binary input signals produce a truth table with 2³=8 different states. Each of these states require a defined gate output.

Four wave mixing is well known in the art as a third order nonlinear process that mixes three separate optical signals: two “pump” signals and a “source” signal. Characteristics of an output wave depends on a specified relation among all three input signals.

At the receiver, the logic information in the signal may be recovered. For example, a polarizer may be used to change the coding format from polarization shift keying to intensity modulated.

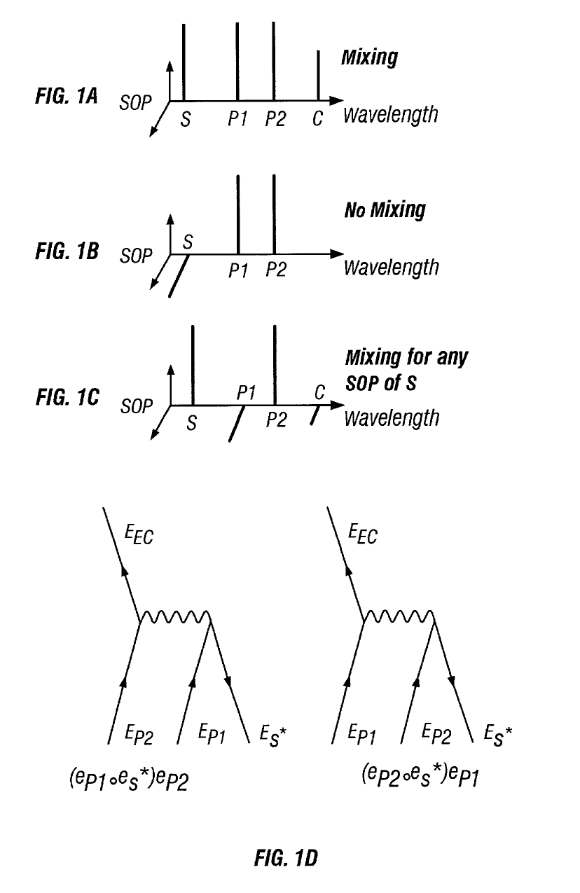

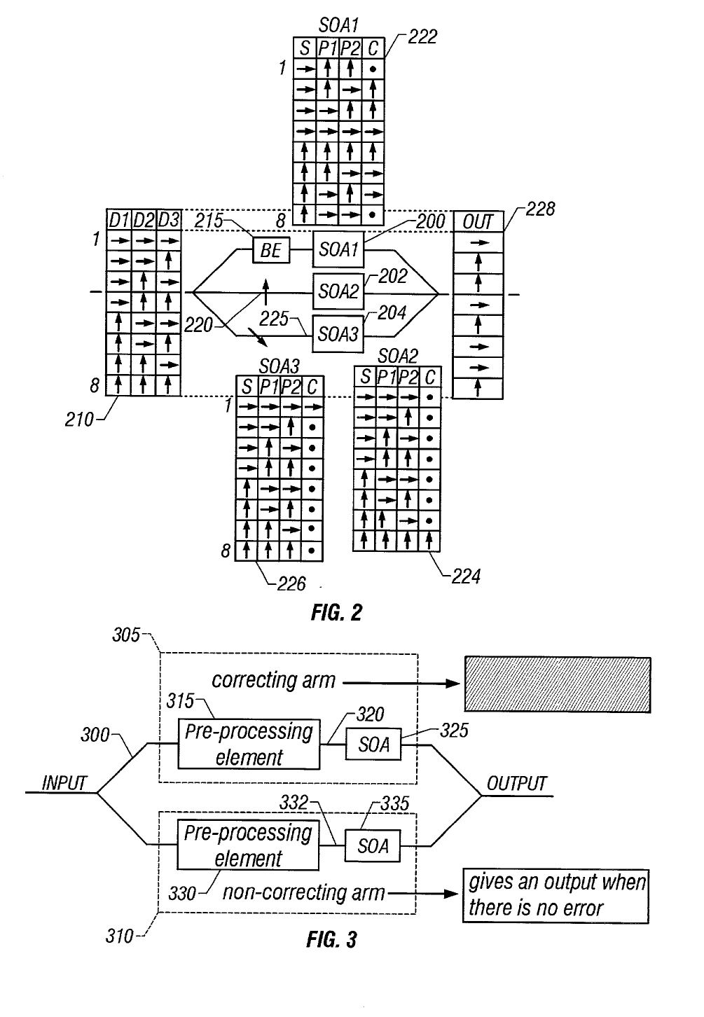

The polarization characteristics of the relationship between waves in a binary polarization shift keying system is shown in FIGS. 1A-1D. Three input waves, including two pump waves P1 and P2, and a source wave S are caused to four wave mix. The four wave mixing may occur in a semiconductor optical amplifier shown as 200 in FIG. 2 or in some other element that comes as a non-linear interaction. A new conjugate wave “C” is created from the mixing. The new wave is created at the optical frequency

ω_{c}=ωₚ₁+ωₚ₂−ωₛ,

where ωₚ₁, ωₚ₂, and ωₛ are the optical frequencies of the three input waves P1, P2 and S, respectively.

The mixing occurs as follows. When all light waves are parallel as shown in figure 1A, then mixing efficiency is the highest. The conjugate output wave C has the same polarization as the inputs.

On the contrary, when the source wave S is orthogonal to the two pump waves P1 and P2, as shown in FIG. 1B, there is no mixing at all. Hence, there is no power in the conjugate output wave.

In the third case, where the two pump waves are orthogonal, and the source wave S is parallel to one of them, mixing occurs at half the efficiency. The conjugate output C will be parallel to the other pump wave, and produced at about half the amplitude of the other wave.

This may be described mathematically as

E_{c}ê_{c}=ηEₚ₁Eₚ₂Eₛ*(μₚ₁ₛ(êₚ₁·êₛ*)êₚ₂+μₚ₂ₛ(êₚ₂·êₛ*)êₚ₁+μₚ₁ₚ₂(êₚ₁·êₚ₂)êₛ*)

where Eᵢ and êᵢ, I=s, p1, p1, c, are the field amplitudes and the SOP-vectors of the signal, the two pumps and the conjugate, respectively. Furthermore, η is an efficiency coefficient and μ₁ⱼ, i,j=s,p1,p2, are mixing coefficients.

The last term in the above equation corresponds to the mixing caused by a local interaction between the pump-waves. In a rectangular waveguide, this term can be neglected if the state of polarization (“SOP”) vectors of the pumps coincide with either the TE or the TM-mode. However, if the SOPs of the pump waves are not fully TE or TM, the last term is finite in an SOA. In this case, the nonlinear effects depend on the input SOP even in a device where the amplification is polarization independent. Therefore, a reference axis which is parallel with the TM-mode of the SOA may be used. From the equation it is apparent that the output SOP is determined by a combination of the SOPs of the signal and both pump waves. Also, when the SOPs of the three light waves are orthogonal or parallel to the reference axis, the scalar products will be either 0 or 1. E_{c}=0 only when êₚ₁ and êₚ₂ are parallel with each other and orthogonal to êₛ, as was described earlier in FIG. 1B.

The operation of a four wave mixer is well known in the art, but for completeness, an alternate way of looking at the interaction will be described.

FIG. 1D shows a Feynman diagram of four wave mixing. Two of the photons, that is one of the pump photons and the source photons, interact to form a grating which scatters the other photons. The two photons with frequencies λ₁ and λ₂ may be input to a media that has a certain non-linearity where λ₁ is not equal to λ₂. The resultant intensity is

|ε₁|²+|ε₂|²+2|ε₁|·|ε₂|COS[(ω₁−ω₂)t].

As can been seen, this causes a pulsation at a frequency Ω=Ω₁−Ω₂ assuming there is energy in a · product. This energy in a · product will only occur when one of p1 or p2 is polarized the same as S. Assuming this grating occurs, the pulsation occurs at a frequency λ.

These polarization properties may be used to create a truth table for the four wave mixing. Table 1 shows the truth table between the probe wave S, the first pump wave P1, and the second pump wave P2. The state of polarization of the conjugate C is shown for all input states of polarization when binary polarization shift keying is used.

TABLE 1
Polarization Mixing table for first order FWM

| S | P1 | P2 | C |
|---|---|---|---|
| → | → | → | → |
| → | → | ↑ | ↑ |
| → | ↑ | → | ↑ |
| → | ↑ | ↑ | ▪ |
| ↑ | → | → | ▪ |
| ↑ | → | ↑ | → |
| ↑ | ↑ | → | → |
| ↑ | ↑ | ↑ | ↑ |

In the table 1, the arrows are used to represent signals with vertical or horizontal polarizations. The black dot indicates that no mixing has occurred.

Binary states are represented by orthogonal linear states of polarization. The signals can be carried by a fiber in which case the states are transposed along the fast and slow axes of a polarization maintaining (“PM”) fiber.

The “not” logic function may be implemented in this system by a passive element such as a half wave plate or a cross splice.

Byte-wise transmission may be achieved by assigning each of a plurality of bits to a separate wavelength channel in the optical signal. In this way, the single optical fiber acts as a parallel data bus. The logic can operate on a whole word, of any desired width, at any time.

FIG. 2 shows a system using polarization properties of light to form an all optical logic gate.

In FIG. 2, three parallel semiconductor optical amplifiers 200, 202, 204 are used. Each of the semiconductor optical amplifiers has a corresponding input device 215, 220, 225. Each input device changes some aspect of the optical input to its corresponding semiconductor optical amplifier, i.e., 200, 202, 204, so that the SOA's each receive a different set of input waves for a specified bit combination.

The operation can be explained with reference to the mixing tables shown in the FIG. 2. Mixing table 210 shows a relationship between the data bits. The data bits D1, D2 and D3 are shown. The first data bits D1 may correspond to the source wave S, with the other data bits D2 and D3 corresponding respectively to the two pump waves P1 and P2. In this table, and all other tables of FIG. 2, a horizontal arrow corresponds to horizontally polarized light, and is called a “0”. A vertical arrow refers to vertical polarization, and is called a “one”. Of course, the opposite sense is also possible.

The input data bits D1, D2, D3 are each applied to a respective input device. The input device for semiconductor optical amplifier No. 1 (element 200) is formed by a birefringent element 215. The birefringent element inverts the state of polarization of the source S, but not the pump waves P1 or P2. The resultant polarization states applied to semiconductor optical amplifier 200 are shown in the mixing table 222.

The second semiconductor optical amplifier 202 has an input device 220 formed by a vertical polarizer. The vertical polarizer effectively blocks horizontally polarized light, so that horizontally polarized light may result in a zero conjugate. Hence, the input waves to form the states shown in mixing table 224.

Conversely, the third semiconductor optical amplifier 204 has an input device 225 formed by a horizontal polarizer. This results in the mixing table 226, where the horizontal polarizer effectively passes all horizontal light, but blocks all vertical light.

Each of the mixing tables 222, 224, 226 shows the states of polarization of the signal S, pumps, P1 and P2, and conjugate C of the four wave mixing process in each semiconductor optical amplifier, after the respective input device. Again, black dots correspond to no power in C. A useful feature of this embodiment is that the input devices are selected in this embodiment so that for any combination of input states, only one of the semiconductor optical amplifiers produces an output that has nonzero power. Since only one semiconductor optical amplifier produces an output at any given time, the output can be formed by a simple combination of the conjugate values C of the three output arms. No interference is caused between the outputs. The output table 228 therefore refers to the conjugate which may be a simple combination of the three arms. This table has a mathematical relation which effectively forms a three bit, modulo 2 addition.

In this particular embodiment, the different input cases for the truth table are each treated in a specific way. Any case is tested by only one semiconductor optical amplifier, so that no interference is produced at the output.

Since parallel devices are used, time synchronization between these devices may be necessary. Integrating the semiconductor optical amplifier devices on a single chip may easily produce matching characteristics among the devices. For example, sub picosecond accuracy and matching may be obtained.

This system uses the polarization properties of a nonlinear process to perform a logic operation. Any arbitrary logic operation can be formed by appropriate selection of the optical amplifiers and the input elements. Each operation may be carried out at a single wavelength in this embodiment.

In addition, the four wave mixing process may output the inverse of the source wave when the pumps are orthogonal. This inverse value forms the “not” for use in other logic operations. Since the polarization of the signal carries its logic state, a “not” function may also be effected by inverting the polarization state in some other way, such as by a cross splice.

The input devices as described herein may include a wavelength selective element other than the birefringent element. It may also include polarization rotators that are non wavelength selective, in addition to the non wavelength selective polarizer.

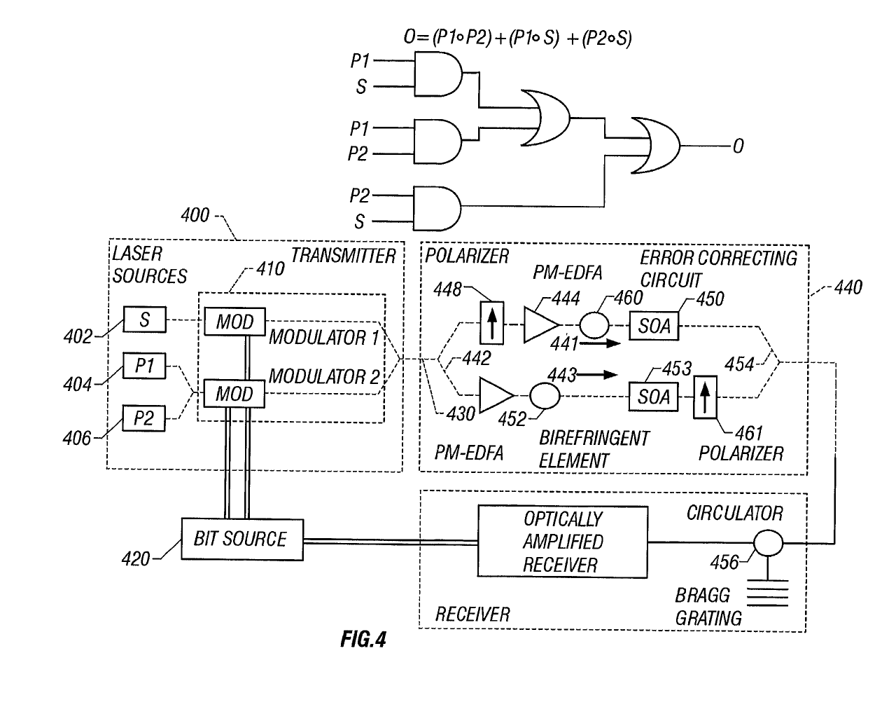

Another embodiment shown in FIGS. 3 and 4 relates to error detection and correction techniques for errors on an optical fiber. One technique of correction uses parity bits for error detection and correction of error in the optical domain. In the prior art, this operation may be performed in the electrical domain. Encoding is performed electrically prior to transmission. Decoding is performed electrically after detection. The polarization shift key modulated transmission may carry out error correction coding using all optical spectral logic.

FIG. 3 shows the basic optical error-correcting system. The input 300 is sent to two, parallel optical processing elements 305, 310 through an optical splitter. Each optical processing element forms an arm. Each arm includes a preprocessing element 315 or 330 which changes some aspect of the polarization of the input light. The polarization adjusted light 320 or 332 is then sent to an SOA 325 or 335. The correcting arm 305 is configured such that when it detects an error in the input, that error is automatically corrected by the four wave mixing process in the SOA 325. The input is simultaneously coupled to the non correcting arm 310 which gives an output only when there is no error.

As in the above embodiment, since there cannot simultaneously both be an error, and not be an error, only one arm produces an output at any given time. Therefore, mixing products are avoided. The meaning of the term “gives an output”, however, refers to an output that is within the salient frequency of interest. Since the SOAs 325 and 335 carry out four wave mixing, they may actually produce frequency outputs even for inputs which do not have specified criteria. However, these frequency outputs are not within the frequency range of interest, and hence can be filtered out as explained herein.

This embodiment may use a Hamming (3,1) code with one data bit and 2 parity bits. Binary information may be sent as a three bit word that includes the data bit along with two check bits.

The transmitted word [D1, D2, D3] is sent as a vector which is either [0,0,0] or [1,1,1]. Each data bit Dᵢ may correspond to a different wavelength λᵢ, where i is 1,2 or 3. If an error occurs on any bit, the word can still be detected. The truth table for error correction in such a code is shown in table 3.

The error correcting receiver detects the erratic bit, and corrects the output data.

A truth table as shown in table 2 can be used to decode this information.

TABLE 2
Truthtabte for decoding the Hamming (3,1) code

| D1 | D2 | D3 | OUT |
|---|---|---|---|
| 0 | 0 | 0 | 0 |
| 0 | 0 | 1 | 0 |
| 0 | 1 | 0 | 0 |
| 0 | 1 | 1 | 1 |
| 1 | 0 | 0 | 0 |
| 1 | 0 | 1 | 1 |
| 1 | 1 | 0 | 1 |
| 1 | 1 | 1 | 1 |

TABLE 3
Truth-table for error correction
using the (3,1) Hamming Code

| C1 | C2 | C3 | EC |
|---|---|---|---|
| 1 | 1 | 1 | 1 |
| 0 | 0 | 0 | 0 |
| 1 | 1 | 0 | 1 |
| 1 | 0 | 1 | 1 |
| 0 | 1 | 1 | 1 |
| 0 | 0 | 1 | 0 |
| 0 | 1 | 0 | 0 |
| 1 | 0 | 0 | 0 |

According to this truth table, either two or three “1”s at the input produces an output of “1”. Otherwise, the output is zero.

The logical expression

EC=(C1·C2)+(C2·C3)+(C3·C1)

represents the operation, where the dot is logical “and”, and the + is logical “Or”. EC represents the error corrected information. This can also be written in terms of a triple product Boolean operation as

EC=(C1∩C2∩C3)∪(\overline{C1}∩C2∩C3)∪(C1∩\overline{C2}∩C3)∪(C1∩C2∩\overline{C3}) (2)

The four wave mixing process is used to create the error corrected channel as explained in the following.

The co propagating electric field created by the four wave mixing process is given by

Eₖ(ω_{EC}=ω_{C1}+ω_{C2}−ω_{C3})∝Xₖₗₘₙ⁽³⁾E₁(ω_{C1})Eₘ(ω_{C2})Eₙ*(ω_{C3}) (3)

Where Eₖ is the electric field ωᵢ, i=EC, C1, C2 and C3, is the angular frequency of the optical wave and (*) denotes complex conjugation. Xₖₗₘₙ⁽³⁾ is the third-order nonlinear susceptibility, which is a tensor of rank four. This is dependent on the state of polarization of the electric fields of C1, C2 and C3.

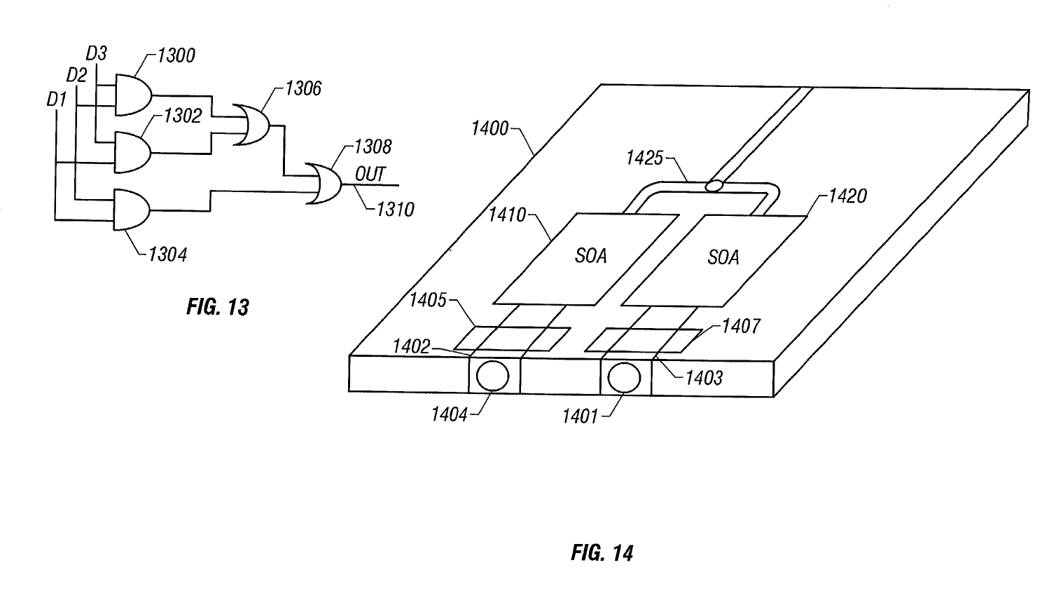

Computation of this result may be embodied in a circuit made from two-input logic gates as shown in FIG. 13. The data bits D1, D2, D3 are input to 2-input and gates 1300, 1302, 1304. The outputs of the first two and Gates 1300, 1302 are ORed by or gate 1306. The output of that or gate 1306 is then ORed with the output of the other or gate 1304, in or gate 1308. The final output 1310 is obtained.

This system requires three levels of gates. In the all optical domain, on the other hand, the full truth table may be embodied in a single level of gates using the techniques described above.

Binary polarization shift keying modulation may be used with 0s assigned to horizontal polarization, and is 1s assigned to vertical polarization, or the opposite. Using the system of FIG. 2 with the truth table in table 1, error correction can be easily carried out in a single level of gates.

A block diagram of the system is shown in FIG. 3 and more detailed diagram is shown in FIG. 4. Transmitter 400 is formed with three laser sources 402, 404, 406, which may be external cavity lasers. Each laser respectively produces an output signal. The laser 402 produces the source wave S at a wavelength of 1549.9 nm. The two pump waves P1 and P2 are respectively produced by lasers 404 and 406 at 1547.8 nm for P1, and 1546.8 nm for P2. Other wavelengths may of course be used.

The lasers are all applied to a polarization shift keying module 410 which modulates the lasers at a desired bit rate such as 2.5 Gbps using a bit sequence generated in bit source 420. In the setup shown in FIG. 4, the bit source 420 can be a pseudorandom pattern generator.

The modulator 410 may allow any one wavelength to be altered independently from the other two wavelengths. S, P1 and P2 are respectively assigned to the coding bits D1, D2 and D3. The modulated light is sent over the channel 430 to the input of receiver 440. At the receiver 440, the input light from the transmitter 440 is divided at an optical beam splitter or coupler 442 into two substantially equal parts forming an upper path 441 and a lower path 443. Each path is amplified in Erbium doped fiber amplifier, 444 and 446. The upper path 441 is first polarized by polarizer 448 which forms the input device for optical energy prior to its application to SOA 450. The lower path 443 has a birefringent element 452 forming the input element for SOA 453. The lower path 443 has a polarizer 461 located after the SOA 453. In this way, the output signal from the two paths becomes intensity modulated.

This polarizer 461 would not be present in other embodiments, where this device was being used as a building block along with other building blocks; in that case, the polarization modulation would be retained.

The birefringent element may change the state of polarization of the source beam by 90 degrees, while leaving constant the states of polarization of the pump P1 and P2. In one implementation, the birefringent element may include a 75 cm long PM fiber, having a birefringent axis spliced at 45 degree angle to the axis of the input and output fibers. This may form a wavelength difference of approximately 2½ nm, over which the fiber operates as a half wave plate and a full wave plate. The temperature of the fiber may be changed to tune and stabilize the wavelength selection.

The system in FIG. 4 may use polarizers in each path to convert the polarization shift keying to intensity modulation. The upper arm 441 including the polarizer 448 at the input, and the lower arm 443 including the polarizer 461 at the output. In the upper arm 441, mixing will only occur when the input word is [1,1,1] due to the polarizer 448. All other cases will mix in the lower arm 443. The polarizers 448 and 461 are oriented to be orthogonal to each other to ensure the above operations.

Finally, the outputs of the two arms are added at optical coupler 454 and the conjugate is filtered out by band pass filter 456, which may be an optical circulator with a fiber Bragg grating. Since there is no simultaneous processing in the two semiconductor optical amplifiers 450,453, , interference between the arms 441,443 may be minimized.

Since there is a conversion to intensity modulation, the semiconductor optical amplifier that would otherwise need to mix the case of [000] to produce zero may be omitted. Therefore, the entire operation can take place with two SOAs.

In operation, in the absence of any errors, D1, D2 and D3 are input in parallel. Mixing occurs in the semiconductor optical amplifier 450, and produces the same binary states as the input bits. Hence, this upper arm 441 is called the non correcting arm, since it generates an output without error correction. The non correcting arm implements the Boolean operation D1·D2·D3. In this embodiment, the polarizer 448 changes the polarization shift key modulation to an amplitude shift key modulation. An alternative embodiment may maintain the polarization shift key modulation by using two non correcting arms, each

with a polarizer respectively aligned to the fiber. In the case where D1, D2 and D3 are all the same, the birefringent element 452 causes D3 to be orthogonal to D1 and D2. No mixing occurs.

In operation, when one of the fields is orthogonal to the other two, corresponding to an error on the orthogonal bit, a product wave at Ω_{ec} may be generated when D1 and D2 are orthogonal. In this case, D3 creates a grating with the one of D1 or D2 that has a polarization that is parallel to D3. This scatters energy off the third wavelength to generate a four wave mixed signal at Ω_{ec} that is orthogonal to D3.

In the specific implementation of the circuit, in the presence of errors, D1, D2 and D3 will not all be parallel, and hence will not all pass through the polarizer 448. Hence, no mixing at all will occur in the first optical amplifier 450. Two possible cases of mixing are known. When the error is in D3, that error is orthogonal to both D1 and D2. After passing through the birefringent element 452, D3 then becomes parallel to D1 and D2. Therefore, the mixing signal in the second semiconductor optical amplifier 453 will have the same binary state as D1 and D2. The error on D3 is thus corrected.

When the error is on either D1 or D2, then D3 gets inverted by the birefringent element and aligns with the incorrect bit. This hence forms a grating which will scatter off the correct bit in order to provide a mixing signal parallel to the correct bit. This therefore corrects errors in one of the bits. This lower arm 443 can be called the correcting arm. The correcting arm implements the operation

(\overline{C1}∩C2∩C3)∪(C1∩\overline{C2}∩C3)∪(C1∩C2∩\overline{C3})

In operation, the result may be watched using an optical spectrum analyzer. The power levels launched into the semiconductor optical amplifiers may be between 10 and 100 mw. This may heavily saturate those amplifiers. However, in the error-free, [000] case, the optical power is launched through the upper semiconductor optical amplifier 450. This quickly desaturates that amplifier.

The gain of this optical amplifier may also be limited by an idler wave sent from a fiber ring laser 460 at low-power, and at a higher wavelength, e.g. at 1518 nm. A combiner 462 may be used to combine with the data signals. The combination may be orthogonal to avoid interference with the mixing process.

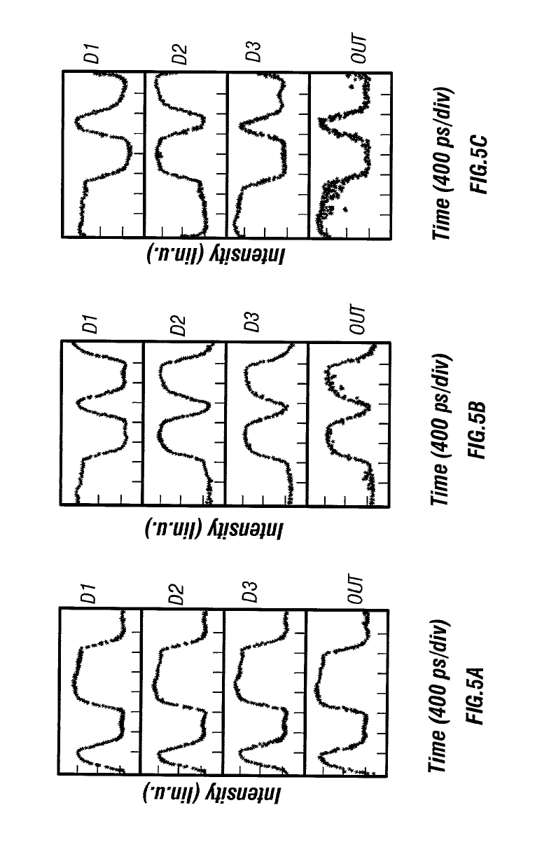

The function is shown in the wave chart of FIGS. 5A-5C. FIG. 5A shows the three input bits D1, D 2 and D3 and the output bit. If there are no errors, then the output bit is the same as both input bits as shown in FIG. 5A. FIGS. 5B and 5C show the case where either D2 or D3 is not the same as D1. The correct data, however, is still recovered, as shown in the outputs of FIGS. 5B and 5C. Errors in D2 are not specifically shown since they correspond to the identical mixing process as the errors in D3.

In this embodiment, the input devices and logic levels are formed such that the four wave mixing product at Ω_{ec} occurs in only one semiconductor amplifier that any given time. In this way, interference between the desired mixing signal and additional signals, can be avoided. The input devices can be a polarizer as described above with a transmission axis aligned to either fast or slow axis of the polarization maintaining fiber. A birefringent element is also described.

The above embodiment uses only two semiconductor optical amplifiers, since the polarization shift key format on the error corrected channel is not maintained.

FIG. 5C shows noise in the output signal, since this combination, where the D1 and D3 are the same but D2 is in error may have the lowest four wave mixing efficiency. Still the logic function performs as desired.

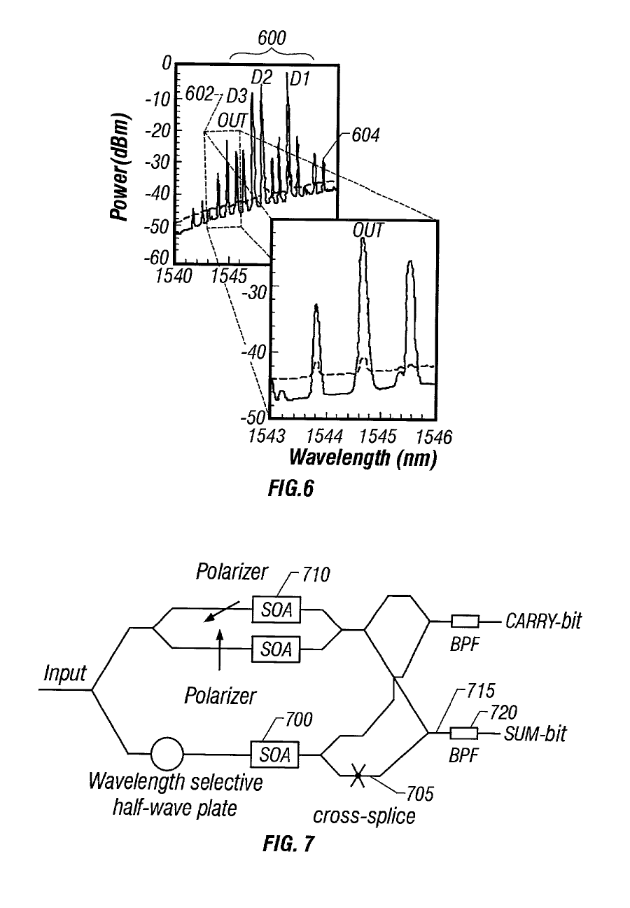

FIG. 6 shows the spectrum that occurs when a [111] combination is launched into the gate.

The top figure part in FIG. 6 shows the entire spectrum, while the lower figure part in FIG. 6 shows a detailed view of the output portion of the spectrum. In FIG. 6, the portion shown as 600 represents the three signals data bits D1, D2, D3. Note that each of these data bits may be at a different wavelength. The output signals 602 are themselves at different wavelengths. Note that the four wave mixing process also produces other output signals such as 604. These signals, however, can either be filtered or ignored. Hence, for purposes of terminology, any signals such as 604, which are outside of the frequency band of interest, are simply ignored.

The solid line in FIG. 6 shows the spectrum at the output of the non-correcting SOA 450 in FIG. 4. This is where the mixing occurs for the [1,1,1] combination. The dotted line spectrum shows the output at the correcting SOA 453 where mixing is minimized. Suppression between the outputs may be close to 20 DB.

The inventors also recognize that the same operation which is used to effect the error correcting can also be considered to correspond to the carry bit of the three bit, modulo two addition. Hence, this same circuit can be used to implement a sum function for a three bit addition.

FIG. 7 shows how a circuit with a similar layout can be used to implement the sum function for a three bit modulo 2 addition. This sum function can be giving as

SUM=C1⊕C2⊕C3 (5)

where “⊕” denotes the logical EXOR. This expression can be rewritten in terms of triple-product functions as

SUM=(C1#C2∩C3)∪(\overline{C1}∩\overline{C2}∩C3)∪(C1∩\overline{C2}∩\overline{C3})∪(\overline{C1}∩C2∩\overline{C3}) (6)

this is done by taking the output of the correcting arm 700 of the circuit, and an inverting the polarization of output e.g. using cross splice element 705. The inverted output is combined with the output of the non correcting arm 710. The combined value 715 is filtered by a band pass filter 720 to provide the sum bit. The other arm is used to generate the carry bit. In this way, the same circuit carries out two different operations/truth tables using the same structure/material.

This sum bit noted above also corresponds to the parity of the three bits D1, D2, D3. Therefore, this same circuit can be used to generate parity bits for encoding other Hamming codes.

An encoder for a (7,4) Hamming code takes four data bits D1, D2, D3, D4 and generates three additional parity bits given by

P−(412)=D4⊕D1⊕D2 (7a)

P−(423)=D4⊕D2⊕D3 (7b)

P−(413)=D4⊕D1⊕D3 (7c)

i.e., the parity bits are “SUM” bits of the 3-bit additions of D4 with two additional bits [Dᵢ, Dₖ], (i,k=1,2,3) from the remaining three bits. While D4 is taken as the example here, it should be understood that any other bit could alternately be selected. For spectrally placed channels [D1-D4], each ND-FWN of D4 with [Dᵢ,Dₖ] may occur at a different wavelength channel. These values are given by

Eₖ(ω_{P-(412)}=ω_{D1}+ω_{D2}−ω_{D4})∝Xₖₗₘₙ⁽³⁾E₁(ω_{D1})Eₘ(ω_{D2})Eₙ*(ω_{D4}) (8a)

Eₖ(ω_{P-(423)}=ω_{D2}+ω_{D3}−ω_{D4})∝Xₖₗₘₙ⁽³⁾E₁(ω_{D2})Eₘ(ω_{D3})Eₙ*(ω_{D4}) (8b)

Eₖ(ωP−(413)=ω_{D1}+ω_{D3}−ω_{D4})∝Xₖₗₘₙ⁽³⁾E₁(ω_{D1}) Eₘ(ω_{D3})Eₙ*(ω_{D4}) (8c)

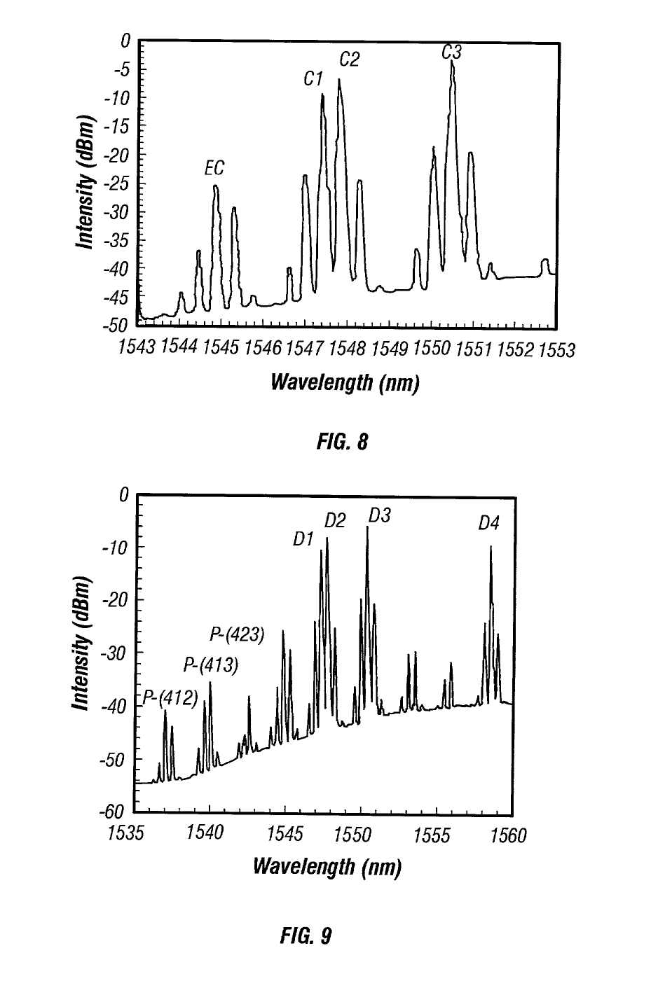

For this operation, the three bit adder circuit of FIG. 7 can be used as an encoder for the (7,4) Hamming code. This simultaneously generates the three parity bits using different four wave mixing processes. The value D4 is common to all of the additions. Therefore, the preprocessing element in one of the arms acts as a half wave plate for D1, D2 and D3, but a full wave plate for D4. The seven bit word at the output of the encoder is in a byte wide format with data and parity on separate wavelength channels. FIG. 8 shows a sample, resultant spectrum.

FIG. 9 shows a wavelength spectrum of four wave mixing signals arising due to the presence of the four wavelength channels D1-D4. FIG. 9 shows D1, D2, D3 and D4 at separate wavelengths. The four wave mixing process forms the parity bits P−(412), P−(413), and P−(423) at separate wavelengths.

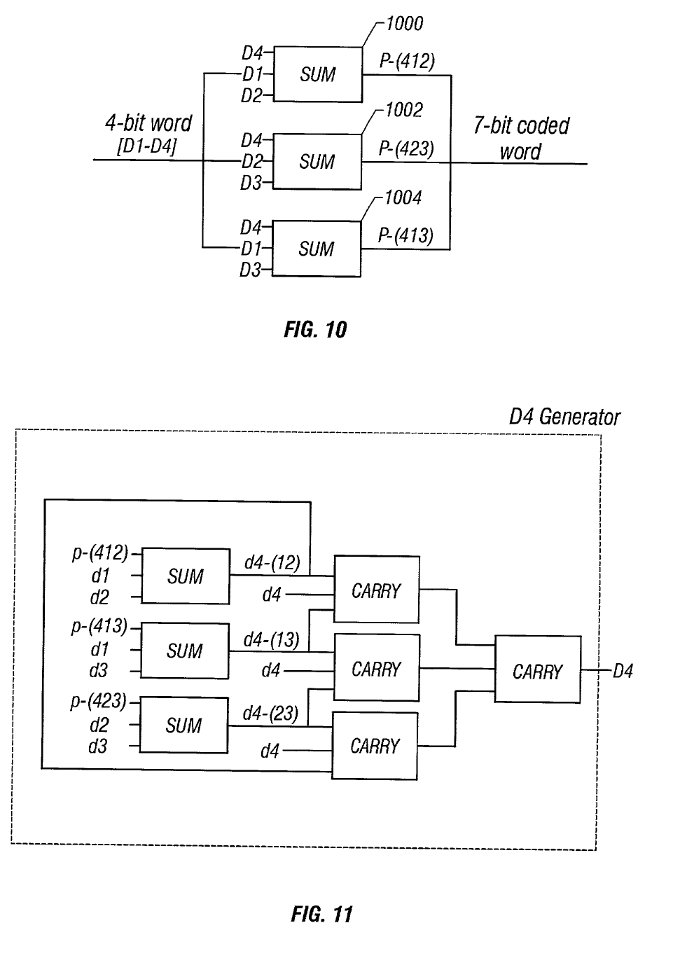

By spreading the frequencies in this way, the four wave mixing process allows three independent logic functions to be implemented in parallel in the single circuit. These adder circuits may be used as building blocks for other functions. For example, these adder circuits may be used as building blocks to form parity bits as shown in FIG. 10.

Each of the sum circuits 1000, 1002, 1004, corresponds the one of the circuits of FIG. 7. The sum the circuit 1000 generates the first parity bit P−(412). Similarly, the other summation circuits 1002 and 1004 generate the other two parity bits. The input data bits and output parity bits are all combined together to provide the seven bit coded word.

The FIG. 7 adder circuits may also be used as building blocks to form a decoder circuit for the (7,4) Hamming code. This is formed by cascading multiple ones of the three bit adder circuits of FIG. 7. As described above, the transmitted code word includes values for the original four bits D1-D4, and the three parity bits marked as P−(412), P−(423), and P−(413).

In the notation that follows, transmitted bits are denoted by upper case, and received bits are denoted by lowercase. The value SUM[A1, A2, A3] and CARRY [A1, A2, A3} represents respectively the sum and carry bits from the modulo 2 addition of three bits A1, A2, A3. Thus, for example, P−(412)=SUM[D4, D1, D2] Note that D4 is present in all three parity bits. It therefore makes sense to check that bit for errors first, although other orders of error checking can also be used.

The received bits are added as

D4−(12)=SUM[p−(412), d1, d2]

this addition ensures that D4 is correctly generated for all possible cases of the received code word, including any which include a single error on any bit. For example,

if error is on d2, i.e. d2=\overline{D2}=D2⊕1, we obtain

d4−(12)=SUM[P−(412),D1,d2]=(D4⊕D1⊕D2⊕D1⊕D2⊕1)=D4⊕1=\overline{D4} (12a)

d4−(23)=SUM[P−(423),D2,D3]=(D4⊕D2⊕D3⊕D2⊕D3⊕1)=D4⊕1=\overline{D4} (12b)

d4−(13)=SUM[P−(413),D1,D3]=(D4⊕D1⊕D3⊕D1⊕D3)=D4 (12c)

In this case, the right side of Equation 11 equals

$$CARRY [ CARRY [ D4 , \overline{D4} , \overline{D4} ] , CARRY [ D4 , \overline{D4} , D4 ] , CARRY [ D4 , \overline{D4} , D4 ] ] = CARRY [ \overline{D4} , D4 , D4 ] = D4 \qquad ( 13 )$$

Similarly, if the error is on d4, i.e. d4−D4⊕1, the right hand side of Equation 11 equals

$$CARRY [ CARRY [ \overline{D4} , D4 , D4 ] , CARRY [ \overline{D4} , D4 , D4 ] , CARRY [ \overline{D4} , D4 , D4 ] ] = CARRY [ D4 , D4 , D4 ] = D4 \qquad ( 14 )$$

and if the error is on any one of the parity-bits, say p−(412), i.e. p−(412)=P−(412)⊕1, the right hand side of Equation 11 equals

$$CARRY [ CARRY [ D4 , \overline{D4} , D4 ] , CARRY [ D4 , D4 , D4 ] , CARRY [ D4 , \overline{D4} , D4 ] ] = CARRY [ D4 , D4 , D4 ] = D4 \qquad ( 15 )$$

FIG. 7 shows the block-diagram of a circuit that generates D4. The other bits [D1-D3] occur symmetrically in the 7-bit word and can be found using the following additions

d1−(42)=SUM[p−(412),d2,D4] (16a)

d1−(43)=SUM[p−(413),d3,D4] (16b)

D1=CARRY[d1,d1−(42),d1−(43)] (16c)

d2−(41)=SUM{p−(412),d1,D4] (17a)

d2−(43)=SUM[p−(423),d3,D4] (17b)

D2=CARRY[d2,d2−(41),d2−(43)] (17c)

d3−(41)=SUM[p−(413),d1,D4] (18a)

d3−(42)=SUM[p−(423),d2,D4] (18b)

D3=CARRY[d3,d3−(41),d3−(42)] (18c)

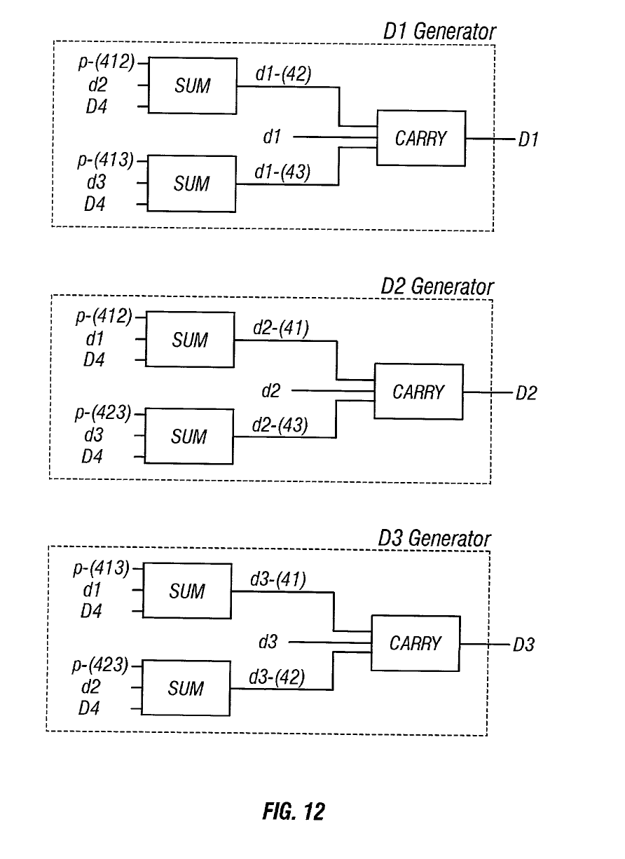

The bits [D1-D3] are also generated correctly for all possible cases where the received 7-bit word has at the most one erroneous bit. FIG. 12 shows the block-diagrams of the circuits that generate the other bits [D1-D3] once D4 has been generated.

FIG. 14 shows another embodiment in which the elements are all formed on a single semiconductor substrate. The substrate 1400 may be a substrate of silicon or any other semiconductor material. The substrate may include an optical waveguide 1402 formed therein. The optical waveguide may have a cross section 1404 which may be asymmetrical, so that it maintains the polarization properties of the optical signal. The substrate may also include an input element 1405 which, as described above, may be a polarizer or birefringent element. A second optical waveguide 1403 with an asymmetric cross section 1401 may be also be formed in substrate 1400. Similarly, an input element 1407 is coupled to the waveguide 1403. In this embodiment, two parallel semiconductor optical amplifiers 1410, 1420 are provided. These two parallel amplifiers have their outputs connected together at 1425 to provide an output. The output 1425 need not be polarization maintaining, if the path of the SOA's includes an element which converts to intensity modulation.

Although only a few embodiments have been disclosed in detail above, other modifications are possible. For example, while the above has described only some types of logic operations, such as Hamming codes, other types of operations such as optical routing, and encryption, as well as other types of Hamming codes, are also contemplated. In addition, other types of error correction may be carried out using this circuit.

The above has described the combination of polarization processes been carried out in semiconductor optical amplifiers. However, other materials can be used for the mixing. In fact, any optical material with high third order nonlinearities and low net dispersion can be used for this purpose. In addition, other mixing techniques besides for wave mixing may be used. For example, other nonlinear processes in which a new wave is created from the phase of a plurality of other waves may be used. This may include cascaded second harmonic generation and difference frequency generation. Also, a material with high fifth order nonlinearities or a cascade of third order nonlinearities could be used.

What is claimed is:

1. An optical gate, comprising:
a logic combining element, receiving a plurality of optical signals having specified polarization properties, and combining said optical signals to produce a logic output that unambiguously corresponds to said plurality of optical signals, based on polarization properties of said optical signals.

2. A gate as in claim 1, wherein there are at least three optical signals.

3. A gate as in claim 1, further comprising a plurality of input elements, modifying a polarization state of at least one of said optical signals prior to input to said logic combining element.

4. A gate as in claim 3, wherein there are a plurality of said logic combining elements, and a plurality of said input elements, each input element associated with each logic combining elements.

5. A gate as in claim 4, wherein said input elements change the polarization in a way such that each combination of input signals produces an output in only one of said logic combining elements.

6. A gate as in claim 1, wherein there are a plurality of said logic combining elements, and wherein each combination of input optical signals produces an output in only one of said logic combining elements.

7. A gate as in claim 6, wherein outputs of said logic combining elements are combined.

8. An optical gate as in claim 1, wherein said input is responsive to polarization shift key modulated optical signals.

9. An optical gate as in claim 1, wherein said signals are configured to form a logic operation between three optical signals.

10. An optical gate as in claim 1, wherein said input includes a plurality of simultaneous bits at a plurality of frequencies, and said logic combining element simultaneously mixes each of said plurality of frequencies to carry out said logic operation on each of said plurality of bits.

11. An optical gate as in claim 1, wherein said logic combining elements are four wave mixing elements, and said signal elements are configured to carry out an error correction scheme using parity bits.

12. An optical gate as in claim 11, wherein said signal elements are configured to form parity bits.

13. An optical gate as in claim 11, wherein said signal elements are configured to decode an error correction scheme by decoding parity bits.

14. An optical gate as in claim 11, wherein said four wave mixing elements include a first four wave mixing element operating to mix signals when there are no errors indicated by said parity bits, and a second four wave mixing element operating to mix signals when there are errors indicated by said parity bits.

15. An optical gate as in claim 13, wherein said error correction scheme includes a Hamming code.

16. An optical gate as in claim 15, wherein said Hamming code is a (3, 1) Hamming code.

17. An optical gate as in claim 15, wherein said Hamming code is a (7, 4) Hamming code.

18. An optical gate as in claim 1, wherein said logic combining element is a four wave mixing element, and at least one four wave mixing elements is configured to carry out multiple truth tables simultaneously.

19. An optical gate as in claim 18, wherein said multiple truth tables are carried out at different frequencies.

20. An optical gate as in claim 18, wherein said multiple truth tables are each carried out in different arms of a circuit.

21. An optical gate as in claim 18, wherein said multiple truth tables respectively obtain a sum bit and a carry bit for a 3 bit add.

22. An optical gate as in claim 18, wherein said error correcting code is a Hamming code.

23. A method, comprising:
modulating a polarization of a plurality of optical signals to represent a logic state; and
carrying out an operation among said plurality of optical signals which corresponds to a logic operation between said plurality of optical signals based on said polarization, and producing an output signal representing a result of said logic operation.

24. A method as in claim 23, wherein there are three optical signals, and said logic state corresponds to an add operation between said three signals.

25. A method as in claim 23, wherein said plurality of optical signals include parallel optical signals at different wavelengths, each of which are modulated in polarization.

26. A method as in claim 23, further comprising coupling said plurality of optical signals over a waveguide that maintains a polarization of said signals.

27. A method as in claim 26, wherein said waveguide includes a polarization maintaining fiber.

28. A method as in claim 26, wherein said waveguide includes a waveguide formed on a semiconductor element.

29. A method as in claim 23, further comprising effecting an inversion operation by inverting a polarization of an optical signal.

30. A method as in claim 27, further comprising effecting an inversion operation using a cross splice and a polarization maintaining fiber.

31. A method as in claim 23, wherein said carrying out an operation comprises four wave mixing said optical signals to provide a new conjugate signal whose polarization indicates said result of said logic operation.

32. A method as in claim 31, wherein said four wave mixing occurs in a plurality of four wave mixing elements.

33. A method as in claim 32, further comprising changing an input to at least one of said four wave mixing elements.

34. A method as in claim 23, wherein said logic operation is carried out in optical element, and selecting operations to be carry out by said optical element so that only one optical element produces an output with nonzero power at a frequency of interest, and any given time.

35. A method as in claim 34, wherein said logic operation includes four wave mixing among said optical signals.

36. A method as in claim 33, wherein said changing an input comprises changing polarizations of certain inputs.

37. A method as in claim 23, wherein said operation includes decoding of an error correcting code which includes parity bits.

38. A method as in claim 37, wherein said error correcting code is a Hamming code.

39. A method as in claim 38, wherein said Hamming code is a (3, 1) Hamming code with two parity bits.

40. A method as in claim 38, wherein said Hamming code is a (7, 4) Hamming code.

41. A method as in claim 25, wherein said carrying out an operation comprises four wave mixing among said optical signals, said four wave mixing been carried out at a plurality of said different wavelengths simultaneously.

42. A method as in claim 23, further comprising carrying out multiple truth tables among the plurality of optical signals, using the same circuit, to produce multiple outputs.

43. A method as in claim 42, wherein said multiple outputs include a sum output and a carry output of a three bit addition.

44. A method as in claim 42, wherein said multiple outputs include parity bits for an error correcting code.

45. A method as in claim 42, wherein said multiple outputs include summing results from a multiple bit operation.

46. A method as in claim 44, wherein said parity bits are parity bits for a Hamming code.

47. A method as in claim 23, wherein said operation comprises decoded an error correcting code-in coded signal.

48. A method as in claim 47, wherein said decoding comprises using a first system to decode signals which include no error therein, and a second system to decode signals which include an error therein.

49. A method as in claim 48, wherein said first and second systems includes systems which carry out four wave mixing between signals.

50. A method, comprising:
encoding an input logic state as a polarization of an optical signal to form a polarization-encoded optical signal;
using said polarization-encoded optical signal to carry out a logic operation; and
detecting a polarization of said polarization-encoded signal, and inverting said polarization to a signal indicative of an output logic state.

51. A method as in claim 50, wherein said logic operation includes an inversion.

52. A method as in claim 51, wherein said inversion includes coupling said signal on a polarization maintaining fiber, and cross splicing said signal to change a polarization thereof.

53. A method as in claim 50, wherein said logic operation comprises a logical AND between a plurality of signals.

54. A method as in claim 53, wherein said logical and comprises carrying out four wave mixing between said plurality of signals.

55. A method as in claim 54, wherein said four wave mixing is carried out in a plurality of different elements, each element producing an output for specified combinations, and only one element producing an output for any specified combination.

56. A method as in claim 53, wherein said logic operation comprises a logical AND between three signals in a single row of gates to produce an output.

57. A method as in claim 50, wherein said logic operation comprises detecting polarizations of a plurality of input signals representing an error correcting code-encoded signal, and producing an output indicating an error-corrected output.

58. A method as in claim 57, wherein said error correcting code is a Hamming code, and said input signals include an input signal and parity bits.

59. A method as in claim 50, wherein said logic operation is decoding of an error correcting code.

60. A method as in claim 59, wherein said logic operation is between a signal bit and at least two parity bits and said output logic state represents an output signal which is corrected by a state of said parity bits.

61. An apparatus, comprising:
an optical signal receiving element, receiving a plurality of polarization-encoded optical signals;
an optical logic element, carrying out a four wave mixing process between said polarization encoded optical signals to produce an output having a polarization representing a logic operation between said plurality of polarization encoded optical signals.

62. An apparatus as in claim 61, wherein said optical logic element includes a plurality of four wave mixing elements, operating in parallel.

63. An apparatus as in claim 62, wherein only one of said four wave mixing elements produces an output for any given combination of logic in said polarization encoded optical signals.

64. An apparatus as in claim 63, wherein there are two of said four wave mixing elements.

65. An apparatus as in claim 63, wherein there are three of said four wave mixing elements.

66. An apparatus as in claim 63, wherein said four wave mixing elements comprise semiconductor optical amplifiers.

67. An apparatus as in claim 62, further comprising at least one input device, each coupled between said signal receiving element and one of said four wave mixing elements, and changing a polarization of said polarization encoded signals to form signals such that only one of said four wave mixing elements produces an output for any given combination of logic in said polarization encoded optical signals.

68. An apparatus as in claim 61, wherein said plurality of polarization encoded optical signals include at least three optical signals, between which said logic operation is to be carried out, each of said at least three optical signals being present at a plurality of different wavelengths representing a multi bit word signal.

69. An apparatus as in claim 61, wherein said logic operation is an operation that produces multiple outputs from said multiple inputs.

70. An apparatus as in claim 69, wherein said multiple outputs include at least a sum bit and a carry bit of a multiple bit addition.

71. An apparatus as in claim 69, wherein said multiple outputs include parity bits of an error correcting process.

72. An apparatus as in claim 61, wherein said logic operation is an operation that produces a single output from multiple inputs.

73. An apparatus as in claim 72, wherein said logic operation comprises obtaining a plurality of bits respectively representing a signal bit and parity bits, including said plurality of bits to said optical logic element, and wherein said output represents an error corrected signal represented by said signal bit and parity bits.

74. An apparatus as in claim 73, wherein said plurality of bits include signal bits and parity bits for a (3, 1) Hamming code.

75. An apparatus as in claim 73, wherein said plurality of bits include signal bits and parity bits for a (7, 4) Hamming code.

76. An apparatus, comprising:
an input, receiving optical signals which are optically encoded to represent a signal bit, and parity bits in an error correcting code;
an optical circuit, including a first circuit part which detects whether values in said signal bit and parity bits include no error, and which passes said values when they indicate no error, and a second circuit part, separate from said first circuit part, which detects whether values in said signal bit include an error and correct said error when detected.

77. An apparatus as in claim 76, wherein said optical signals are encoded via their polarization, wherein one state of polarization of said optical signals represents a first logic level, and another state of polarization of said optical signals represents a second logic level.

78. An apparatus as in claim 77, wherein said optical circuit includes a four wave mixing circuit, which mixes said optical signals to produce an output.

79. An apparatus as in claim 78, wherein said four wave mixing circuit includes a semiconductor optical amplifier.

80. An apparatus as in claim 77, further comprising at least one preprocessing element, coupled between said input and said optical circuit, and processing polarizations to ensure that specified mixing occurs only in either said first circuit part or said second circuit part but not both, for a given input.

81. An apparatus as in claim 80, wherein said preprocessing element includes a polarization rotating element.

82. An apparatus as in claim 80, wherein said preprocessing element includes a polarizer.

83. An apparatus as in claim 76, wherein said input includes a polarization maintaining fiber.

84. An apparatus as in claim 78, wherein said input includes a waveguide formed on a semiconductor chip.

85. An apparatus as in claim 76, further comprising a modulator, producing said optical signals.

86. An apparatus as in claim 76, wherein said input receives a plurality of sets of optically encoded signals, each set including multiple signals at different wavelengths representing different bits of a multibit signal.

87. An optical gate, comprising:
an input part, receiving three optical signals which are optically encoded to represent logic levels;
an operation part, carrying out a logic operation between said three optical signals in a single level of gates, to produce an optical logic output indicative of said operation.

88. A gate as in claim 87, wherein said logic output corresponds to a logical “and”.

89. A gate as in claim 87, wherein said logic output corresponds to both a sum bit of the three bit addition and a carry bit of said three bit addition.

90. An optical logic gate, comprising:
an optical element, receiving three optical inputs and producing an optical output which is a combination based on an error correction code represented by said three optical inputs.

91. A gate as in claim 90, wherein said optical inputs each have states of polarization which are modulated to represent a bit value.

92. A gate as in claim 91, wherein said optical output represents an intensity modulated optical value.

93. A gate as in claim 90, wherein said optical output includes at least one parity bit.

94. A gate as in claim 90, wherein said optical output includes at least one error-corrected bit.

95. A gate as in claim 90, wherein said optical element carries out four wave mixing.

96. A gate as in claim 90, wherein said optical element includes a semiconductor optical amplifier that carries out four wave mixing.

97. A gate as in claim 95, wherein said optical element includes multiple parts, and further comprising at least one optical changing element that changes the optical inputs to said optical element in a way that prevents multiple ones of said multiple parts from producing outputs for any given combination of input logic.

98. A gate as in claim 97, wherein said optical changing element includes a birefringent element.

99. A gate as in claim 97, wherein said optical changing element includes a polarizer.

100. A method, comprising:
encoding each of a plurality of bits making up a multibit word, as different wavelengths in a multi wavelength signal;
optically encoding information into said plurality of bits using polarization shift keying to encode said information; and
carrying out a Boolean logic operation on said plurality of bits substantially simultaneously.

101. A method as in claim 100, wherein said logic operation comprises a “not” operation.

102. A method as in claim 100, wherein said logic operation comprises an addition operation.

103. A method as in claim 102 wherein said addition operation comprises using four wave mixing between said polarization shift keying encoded information bits.

104. A method as in claim 101, wherein said not operations includes inverting a polarity of said bit.

105. A method as in claim 100, wherein said carrying out comprises using a polarization sensitive process to carry out said logic operation.

106. An apparatus, comprising:
a modulator, which produces modulated light whose polarization relates to encoded data, as optical signals to be processed;
at least two semiconductor optical amplifiers, respectively receiving said optical signal to be processed, and carrying out a Boolean operation among said optical signals based on the polarization of said optical signals.

107. An apparatus as in claim 106, wherein said semiconductor optical amplifiers carry out a four wave mixing process among said optical signals to be processed.

108. An apparatus as in claim 106, further comprising using one of said semiconductor optical amplifiers to carry out a three bit adding process.

109. An apparatus as in claim 106, further comprising at least one input device associated with each said semiconductor optical amplifier, said at least one input device changing a polarization of at least one incoming signal.

110. An apparatus as in claim 109, wherein said input devices are selected such that for any combination of input signals, only one of said semiconductor optical amplifiers produces an output at a frequency of interest.

111. An apparatus as in claim 106, wherein said Boolean operation is a binary addition of bits.

112. An apparatus as in claim 106, wherein said Boolean operation is an error correction operation based on input bits and parity bits.

113. An apparatus as in claim 112, wherein said at least two semiconductor optical amplifiers respectively form two separate processing arms for the optical signals, including a first processing arm which corrects bits that are in error, and a second processing arm which passes bits that are not in error.

114. An apparatus as in claim 110, wherein at least one of said input devices is a birefringent element.

115. An apparatus as in claim 110, wherein at least one of said input devices is a polarizer.

116. An apparatus as in claim 115, further comprising using at least one polarizer in each possible path for the optical signals, to convert the polarization-encoded data into intensity-encoded data.

117. An apparatus as in claim 106, wherein said Boolean operation which is carried out is an operation in which multiple truth tables are calculated in each said semiconductor optical amplifier.

118. An apparatus as in claim 117, wherein said Boolean operation is a three bit addition.

119. An apparatus as in claim 117, wherein said Boolean operation includes calculation of parity bits for an error correcting code.

120. An apparatus as in claim 106, further comprising a semiconductor substrate, holding at least said two semiconductor optical amplifiers, and including waveguides therein.

121. An apparatus comprising:
an optical gate, formed to receive polarization encoded signals into multiple four wave mixing elements, such that only one of said multiple four wave mixing element produces an output at any given time.

122. An optical gate as in claim 18, wherein said multiple truth tables respectively carry out formation of different parity bits for an error correcting code.
